(19) United States
(12) Patent Application Publication
(10) Pub. No.: US 2012/0157283 A1
(43) Pub. Date: Jun. 21, 2012

(54) METHOD FOR TURNING A PLIABLE MEMBER OF AN ARTICLE MOVING ALONG A MACHINE DIRECTION

(76) Inventor: Yoichiro Yamamoto, Koeln (DE)

(21) Appl. No.: 13/331,076

(22) Filed: Dec. 20, 2011

Related U.S. Application Data
(60) Provisional application No. 61/425,026, filed on Dec. 20, 2010.
(60) Provisional application No. 61/518,949, filed on May 13, 2011.

(51) Int. Cl. B65H 15/00; B31F 5/00; B31D 5/02

(52) U.S. Cl. 493/394; 493/423

(57) ABSTRACT

A method for turning a pliable member extending laterally from a precursor structure is disclosed. The method may include conveying the precursor structure in a machine direction on a conveyor at a conveyance speed, receiving at least a portion of the pliable member onto an operative twisting moving surface defined by a twisted moving belt situated alongside the conveyor, retaining the portion of the pliable member in contact with the operative twisting moving surface, and driving the twisted moving belt at a speed coordinated with the conveyance speed.

### CROSS REFERENCE TO RELATED APPLICATION

This application claims the benefit of U.S. Provisional Application No. 61/425,026, filed Dec. 20, 2010, and U.S. Provisional Application No. 61/518,949, filed May 13, 2011, the substances of which are incorporated herein by reference.

### BACKGROUND OF THE INVENTION

The business of manufacturing wearable absorbent articles such as disposable diapers and absorbent pants may involve rates of production exceeding 450 articles per minute, in order to sustain a competitive operation. For a typical diaper size this may translate to a speed, at which materials and articles being manufactured move through a line in a machine direction, exceeding 200 meters per minute. Commercial quantities of such articles are made on complex manufacturing lines having modules or components designed to perform the varying tasks required to convert input materials (such as nonwoven webs, polymeric films, loose cellulosic fiber materials, particulate absorbent gelling materials, adhesives, elastomeric strand materials, etc.) to the finished product. A typical line will have machinery components that continuously draw or receive incoming supplies, and perform operations including distributing particulate materials and loose fibers, laminating, flipping, slitting, cutting, activating, gluing, bonding, folding, stacking, packaging, etc., all at the required production rate.

A manufacturing line for such products will often be designed and built to produce an article of a single, unique design; although some lines may have modular components that may be individually adjusted or changed out to effect a relatively minor change in the product produced. Nevertheless, any time it is desired to effect a substantial change in the end product to be produced on the line, it is usually necessary to install different equipment.

A new design for a disposable wearable absorbent pant-like article has been proposed. The design includes a pair of single-section side panels, one at each hip area, formed of a pliable stretch laminate web material. In the manufacturing process contemplated herein, as the article nears completion in the manufacturing line, its chassis is folded laterally through its crotch region and is thereafter conveyed fold nose-first in a machine direction, with the pair of side panels attached to one waist region (e.g., the rear waist region) and extending laterally outwardly in opposite directions therefrom. At this point, for the contemplated design, it is necessary to flip or turn a portion of each of the laterally-extending side panels over, so that they overlie the other waist region (e.g., the front waist region) by a desired, controlled margin, in position for attachment to the other waist region to complete the pant structure.

Various types of equipment for flipping, turning and/or folding pliable materials on manufacturing lines have been developed. In one type of approach, as the material is conveyed along a machine direction, it is brought into contact with a stationary component such as a rod, bar, blade or plow-like structure that changes shape or geometry along the machine direction, in a manner that causes a portion of the material that is in contact with it to be flipped or folded as it moves along the machine direction. This approach has been satisfactory when such portions to be turned or folded are not unduly large and/or pliable; but is not entirely satisfactory in all circumstances, such as where the portion to be so manipulated is both highly pliable and relatively large (i.e., floppy). In the new design for the pant-like article contemplated, the single-section side panels are highly pliable and relatively large. For such members, friction with air (at the machine direction speed) or the stationary surface of the structure may cause undesired and/or unpredictable results such as uncontrolled turning or flipping, or unacceptably imprecise positioning of the member following the operation.

Thus, there is a need for an improved method and equipment to effect the turning or flipping of relatively large, pliable members extending laterally from articles moving along a machine direction.

### BRIEF DESCRIPTION OF THE DRAWINGS

In the drawings, the reference numerals indicate like components or features throughout the views.

FIG. 1 is a perspective view of a disposable absorbent pant-like article;

FIG. 2A is a schematic plan view of a precursor structure to an article similar to that depicted in FIG. 1, shown in a flattened, stretched-out condition (against any elastic-induced contraction in the chassis) with inner surfaces facing the viewer;

FIG. 2B is a schematic plan view of the precursor structure depicted in FIG. 2A, shown with the front waist region folded over the back waist region along a lateral axis, such the outer surfaces of the front waist region face the viewer;

FIG. 2C is a schematic plan view of the precursor structure depicted in FIG. 2B, shown with the side panel front ends turned over to overlay the front waist region;

FIG. 3 is a perspective view of a twist belt mechanism, shown isolated from various accompanying and supporting components;

FIG. 4A is a perspective view of the twist belt mechanism shown in FIG. 3, with added illustrations of disposable pant-like article precursor structures in operable contact therewith, viewed generally along a downstream direction along first waist regions of the precursor structures;

FIG. 4B is a perspective view of the twist belt mechanism shown in FIG. 3, with added illustrations of disposable pant-like article precursor structures in operable contact therewith, viewed generally along a downstream direction along second waist regions of the precursor structures;

FIG. 4C is a perspective view of the twist belt mechanism shown in FIG. 3, with added illustrations of disposable pant-like article precursor structures in operable contact therewith, viewed across the machine direction and across first waist regions of the precursor structures;

FIG. 4D is a magnified view of a portion of the twist belt mechanism and leading precursor structure shown in FIG. 4C;

FIG. 4E is a perspective view of the twist belt mechanism shown in FIG. 3, with added illustrations of disposable pant-like article precursor structures in operable contact therewith, viewed across the machine direction and across second waist regions of the precursor structures;

FIG. 4F is a view of the twist belt mechanism shown in FIG. 3, with added illustrations of disposable pant-like article precursor structures in operable contact therewith, viewed across the machine direction and generally along the planes approximated by the waist regions of the precursor structures;

FIG. 4G is a downstream-looking view of the twist belt mechanism shown in FIG. 3, with an added illustration of a disposable pant-line article precursor structure in operable contact therewith, with its side panel at the front of the operable portion of the twist belt, viewed along the machine direction and along the approximate planes of travel of the waist regions of the precursor structure;

FIG. 4H is a downstream-looking view of the twist belt mechanism shown in FIG. 3, with an added illustration of a disposable pant-line article precursor structure in operable contact therewith, with its side panel at an intermediate location along the operable portion of the twist belt and in a partially-turned configuration, viewed along the machine direction and along the approximate planes of travel of the waist regions of the precursor structure;

FIG. 4I is a downstream-looking view of the twist belt mechanism shown in FIG. 3, with an added illustration of a disposable pant-line article precursor structure in operable contact therewith, with its side panel at the end of the operable portion of the twist belt and in a completely-turned configuration, viewed along the machine direction and along the approximate planes of travel of the waist regions of the precursor structure;

FIG. 5A is a perspective view of additional portions of a manufacturing line including a conveyor system, including the twist belt mechanism shown in FIG. 3 and precursor structures moving in a machine direction therethrough;

FIG. 5B is another perspective view of the equipment and precursor structures shown in FIG. 5A;

FIG. 5C is another perspective view of the equipment and precursor structures shown in FIG. 5A;

FIG. 5D is another perspective view of the equipment and precursor structures shown in FIG. 5A;

FIG. 6 is a view of components of a twist belt mechanism arranged such that the rotational axes of the pulley components thereof are substantially perpendicular with the machine direction;

FIG. 7A is a view of components of a twist belt mechanism arranged such that the rotational axes of the pulley components thereof are not perpendicular with the machine direction;

FIG. 7B is a view of components of a twist belt mechanism arranged such that the rotational axes of the pulley components thereof are not perpendicular with the machine direction; and shown with precursor structures moving therealong in a machine direction, viewed from one side of the precursor structures;

FIG. 7C is a view of components of a twist belt mechanism arranged such that the rotational axes of the pulley components thereof are not perpendicular with the machine direction; and shown with precursor structures moving therealong in a machine direction, viewed from the other side of the precursor structures;

FIG. 8A is a view of components of a twist belt mechanism arranged such that the rotational axes of the pulley components thereof are substantially perpendicular with the machine direction, and the longitudinal axis of the twist belt shifts laterally;

FIG. 8B is a view of components of a twist belt mechanism arranged such that the rotational axes of the pulley components thereof are substantially perpendicular with the machine direction, and the longitudinal axis of the twist belt shifts laterally, and including additional pulleys that guide the twist belt;

FIG. 9A is a view of components of a conveyor system and twist belt mechanism viewed across the machine direction and generally along the planes approximated by the waist regions of the precursor structures;

FIG. 9B is a view of components of a twist belt mechanism viewed across the machine direction and generally along the planes approximated by the waist regions of the precursor structures; and

FIG. 9C is a close-in view of components of a twist belt mechanism viewed across the machine direction and generally along the planes approximated by the waist regions of the precursor structures.

### DETAILED DESCRIPTION OF THE INVENTION

### Definitions

“Downstream”—with respect to components of a manufacturing line, relates to the general direction of forward travel of materials through the manufacturing line toward completion of a product.

“Inner”—with respect to a pant or feature thereof as described herein, generally refers to the inside, or wearer-facing side, of the pant or feature.

“Lateral” and forms thereof—with respect to a pant or feature thereof as described herein, refers to a direction substantially parallel to its waist edges. With respect to a machine direction, refers to a direction substantially perpendicular to the machine direction.

“Length”—with respect to a pant or feature thereof as described herein, unless otherwise specified, refers to a dimension measured along a line substantially perpendicular to the waist edges of the pant.

“Liquid impermeable”—means substantially resistive to through-penetration of liquid water and urine at room temperature and ordinary conditions of use.

“Liquid permeable”—means substantially permitting of through-penetration of liquid water and urine at room temperature and ordinary conditions of use.

“Longitudinal” and forms thereof—with respect to a pant or feature thereof as described herein, refers to a direction substantially perpendicular to the waist edges of the pant.

“Machine direction”—with respect to a component of a product, refers to any line along the component substantially parallel to the direction of forward travel of the component through the manufacturing line toward completion of a product. With respect to a portion or component of a manufacturing line manufacturing articles, refers to the direction of forward travel of the articles or components thereof toward completion of the products.

“Outer”—with respect to a pant or feature thereof as described herein, generally refers to the outside, or garment-facing side, of the pant or feature.

“Upstream”—with respect to components of a manufacturing line, relates to the general direction opposite that of forward travel of materials through the manufacturing line toward completion of a product.

“Width”—with respect to a pant or feature thereof as described herein, unless otherwise specified, refers to a dimension measured along a line substantially parallel to the waist edges of the pant.

### DESCRIPTION

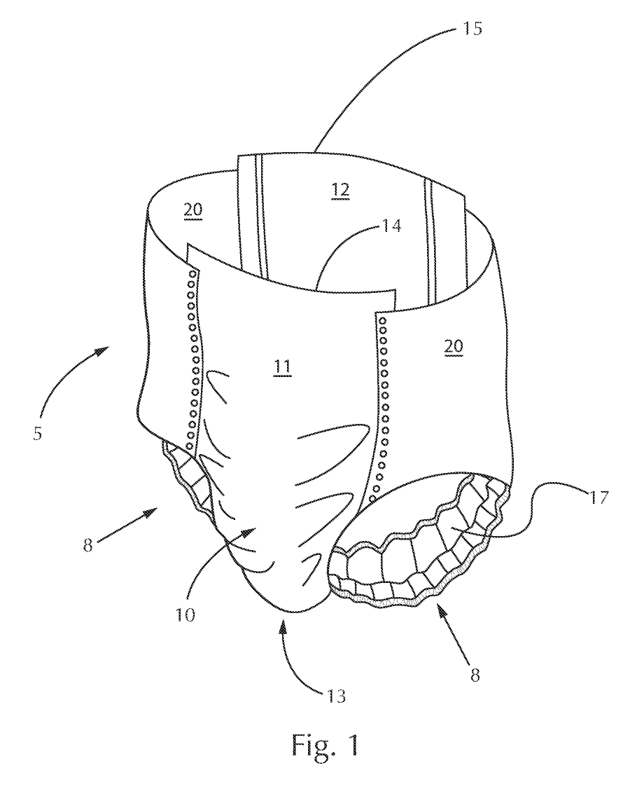

FIG. 1 depicts an example of a disposable absorbent pant-like article 5 that is contemplated. The article may include a chassis 10, with a front waist region 11 with a front waist edge 14, connected to a rear waist region 12 with a rear waist edge 15, by a pair of side panels 20, disposed at the hip areas. The chassis 10 may include components typically included in disposable diapers and training pants, such as a liquid permeable, inner topsheet, a liquid impermeable, outer backsheet, and an absorbent core (not shown) disposed between the topsheet and the backsheet. Typical chassis components, constructions and details are depicted and described in, for example, co-pending U.S. application Ser. No. 12/819,454; the co-pending applications having attorney docket numbers 11957P, 11961P and 11962P filed by Ashton et al. on the same date of filing hereof; and the co-pending application having attorney docket number 11768P by Schneider on the same date of filing hereof; and may also include features and details described and depicted for an “insert” in co-pending U.S. application Ser. No. 12/785,152; these descriptions of such components, constructions and details are incorporated herein by reference in their entirety. The chassis 10, together with the side panels 20, forms a pair of leg openings 8. The inner portion of the chassis may also include a pair of structures variously known as leg cuffs, gasketing cuffs or barrier cuffs 17, which provide a gasketing structure about the insides of the wearer's legs to better contain the wearer's bodily exudates within the article. Side panels 20 may be formed of a stretch laminate material such as described in, for example, U.S. Pats. Nos. 5,167,897; 5,156,793; and 5,143,679; and U.S. application Ser. Nos. 10/288,095; 10/288,126; 10/429,433; 11/410,170; 11/811,130; 11/899,656; 11/899,810; 11/899/811; 11/899,812; 12/204,844; 12/204,849; 12/204,854; 12/204,858; or 12/204,864, the disclosures of which are incorporated herein by reference. Side panels 20 may be laterally elastically extensible so as to provide lateral, hoop-wise stretch for easy and comfortable donning and wear of the article, and to provide lateral, hoop-wise contraction for a neat, secure and comfortable fit.

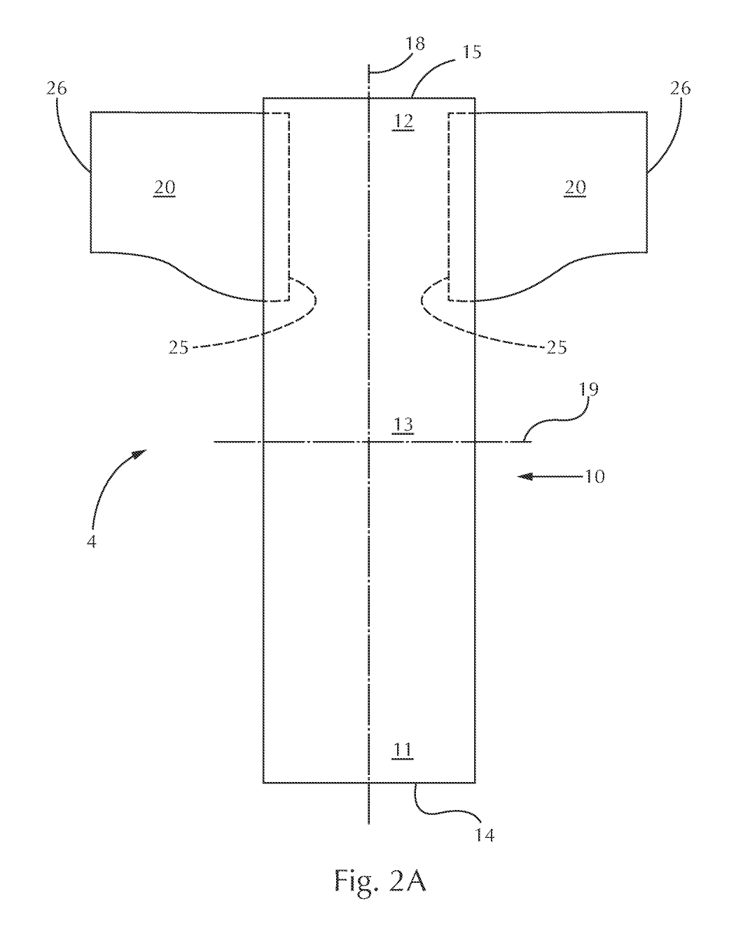

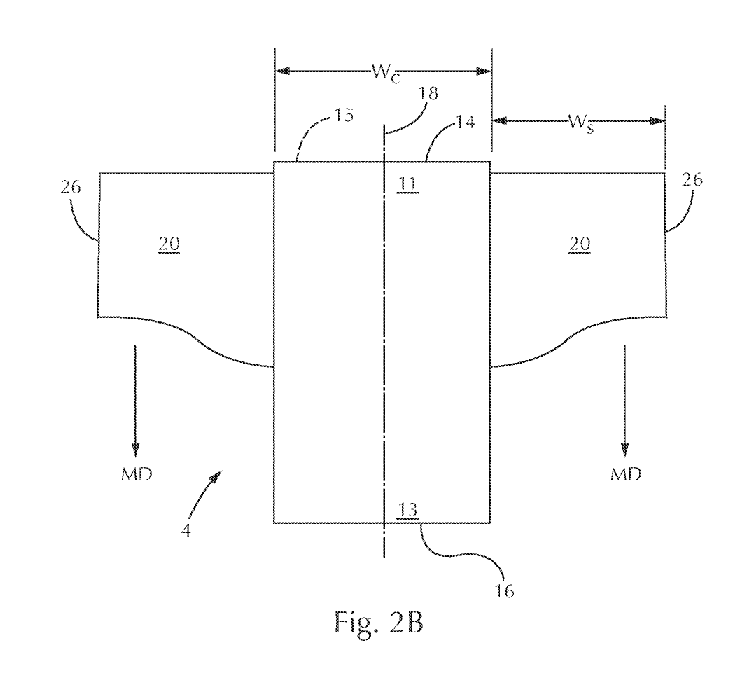

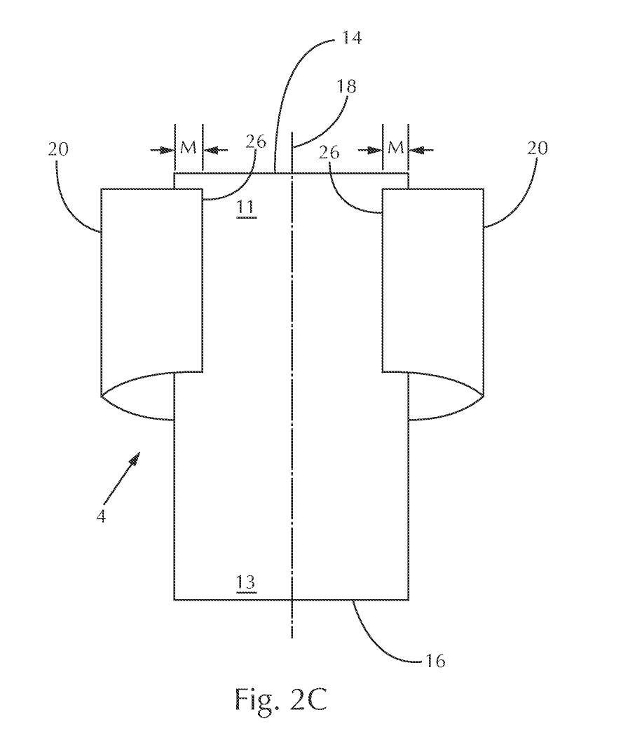

FIG. 2A depicts a simplified schematic view of a precursor structure 4 of the article 5 shown in FIG. 1, as it might appear in a manufacturing line prior to final lateral folding of chassis 10 along lateral axis 19 through crotch region 13, and prior to final attachment of front ends 26 of side panels 20. The precursor structure 4 may have two oppositely-disposed side panels 20 having rear portions 25 attached to the rear waist region 12 of chassis 10 along the longitudinal edges thereof. Rear portions 25 of side panels 20 may be disposed in a layered or sandwiched arrangement among or between the layers (including the topsheet and backsheet) forming chassis 10, such as described in co-pending U.S. application Ser. No. 12/819,454, and suitably bonded to provide attachment therewithin. In another example (not shown), side panels 20 may be formed in part or entirely of a single, belt-like web structure that is continuous from one side panel, across a rear waist region and through the other side panel, and layered over or between the other layers of the chassis 10.

In order to form the article 5 as shown in FIG. 1 from the precursor structure 4 shown in FIG. 2A, the chassis 10 is folded approximately in half about lateral axis 19 through the crotch region 13, topsheet and inner surfaces in, to result in the arrangement shown in FIG. 2B. After folding about lateral axis 19, the precursor structure 4 has fold nose 16. Under contemplated manufacturing methods, the manufacturing process is expected to be designed such that longitudinal axis 18 of precursor structure 4 is parallel with the machine direction MD. It may be desirable further that the manufacturing process be designed such that the folded precursor structure 4 shown in FIG. 2B will be conveyed along the machine direction MD with its fold nose 16 in the leading, forward or downstream-most position, in order to avoid the effect air resistance may have, tending to reopen the folded structure and/or cause it to flap undesirably as it is conveyed downstream through the line. Next, the front ends 26 of side panels 20 must be turned or flipped over so that front ends 26 are placed in the positions shown in FIG. 2C, overlying the chassis backsheet and overlapping the longitudinal edges of the chassis 10, by margins M of a width suitable to provide sufficient area for bonding, according to the selected manner of bonding to the chassis in the front waist region. Front ends 26 may then be bonded to the front region 11 of chassis 10, to complete the pant-like structure of the article 5 as shown in FIG. 1.

As noted, under contemplated manufacturing methods, article 5 is expected to be manufactured such that its longitudinal axis 18 is parallel with the machine direction. Thus, after folding of chassis 10 about lateral axis 19 as described above to achieve the interim configuration depicted in FIG. 2B, side panels 20 extend laterally outwardly from the longitudinal axis, in a direction transverse with the machine direction. When a side panel 20 is of a section of web material extending from a waist region of the precursor structure 4 as shown in FIG. 2B, it may have a free side panel width Ws of between 50% and 100% of the width We of the chassis 10 (measured between the outermost longitudinal edges of chassis 10 proximate the rear waist edge 15. The types of stretch laminate material contemplated herein are relatively pliable, comparable to a soft, relatively thin cloth. At the machine direction MD speeds contemplated herein, the side panels 20 as shown in FIG. 2B are vulnerable to uncontrolled and undesired flapping as a result of their relative pliability and size, as they move through air. For this reason it may be desirable to have a mechanism for retaining, controlling and conveying side panels 20 as they move through the line, and as they are turned over to the position shown in FIG. 2C for subsequent bonding to the front waist region 11. It will be appreciated, therefore, that stationary structures such as rods, bars, plows or other structures which change shape and/or geometry along the machine direction, designed and placed so as to contact the side panels 20 and turn or flip over portions thereof may not provide for sufficient control because of friction with air and stationary surfaces. An alternative method and apparatus for effecting such turning or flipping in a controlled manner is hereinafter described.

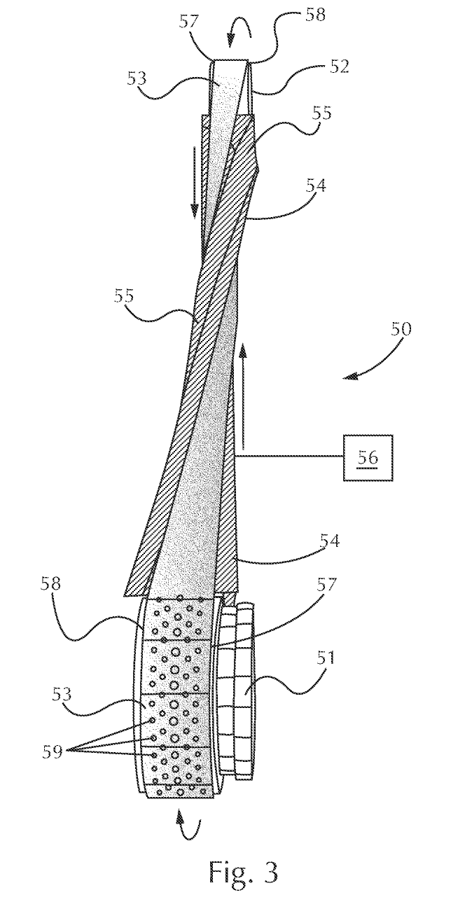

FIG. 3 is a schematic depiction of operable portions of a twist belt mechanism 50, which includes first and second pulleys 51, 52 having a belt 53 riding thereon. Either or both of pulleys 51, 52 may be driven by a motor in the direction indicated by the arrows, while one may be a passive idler. In another example, both of pulleys 51, 52 may be passive idlers, and belt 53 may be driven by a third pulley (not shown) or facing pair of pulleys (not shown) in contact with one of pulleys 51, 52 and/or with belt 53.

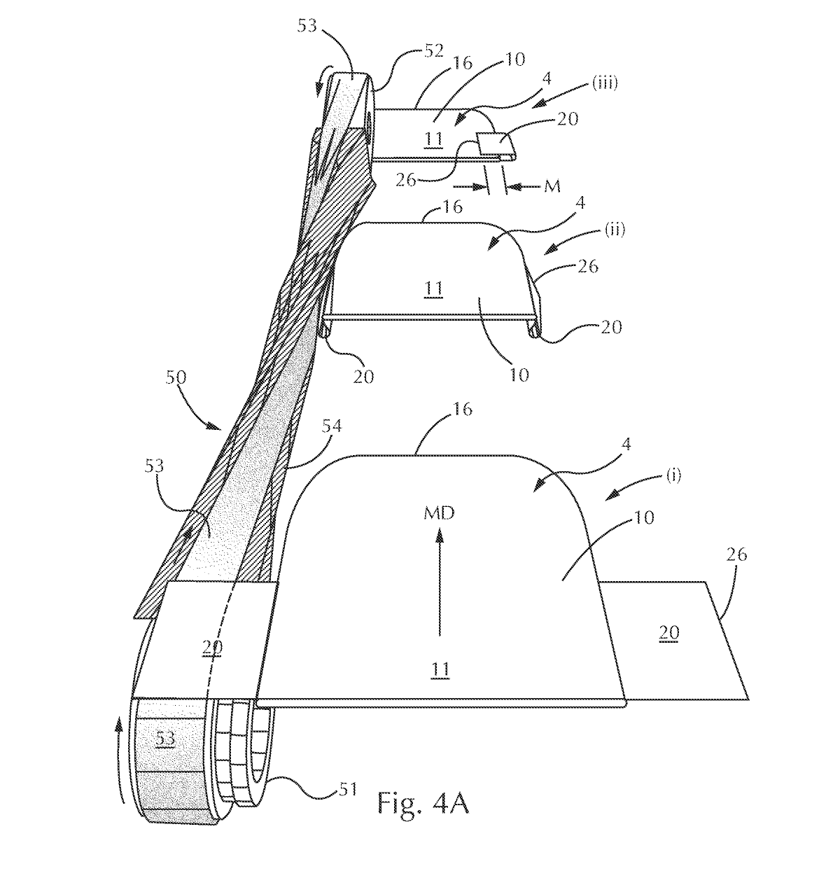

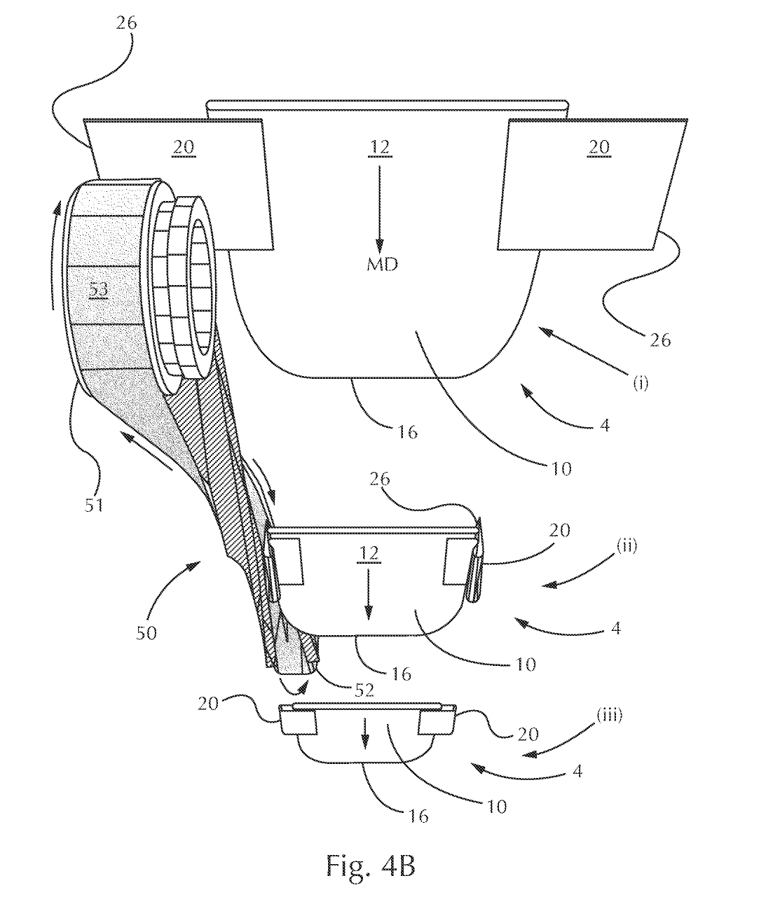

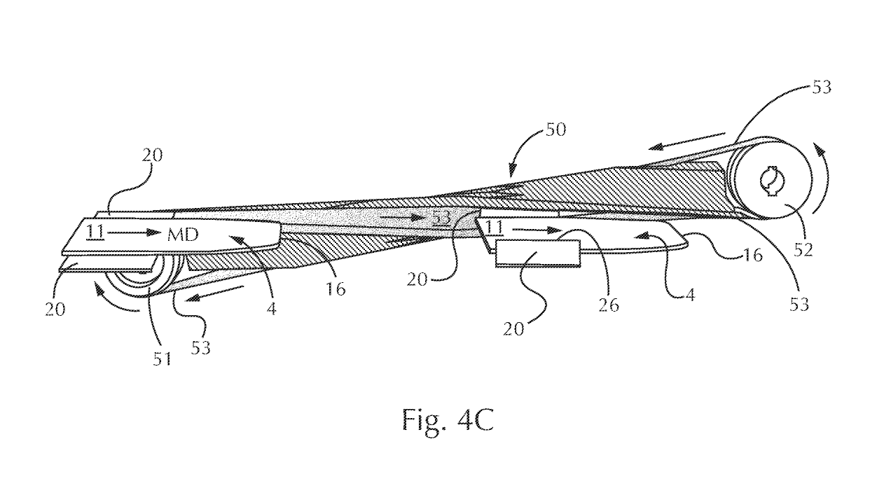

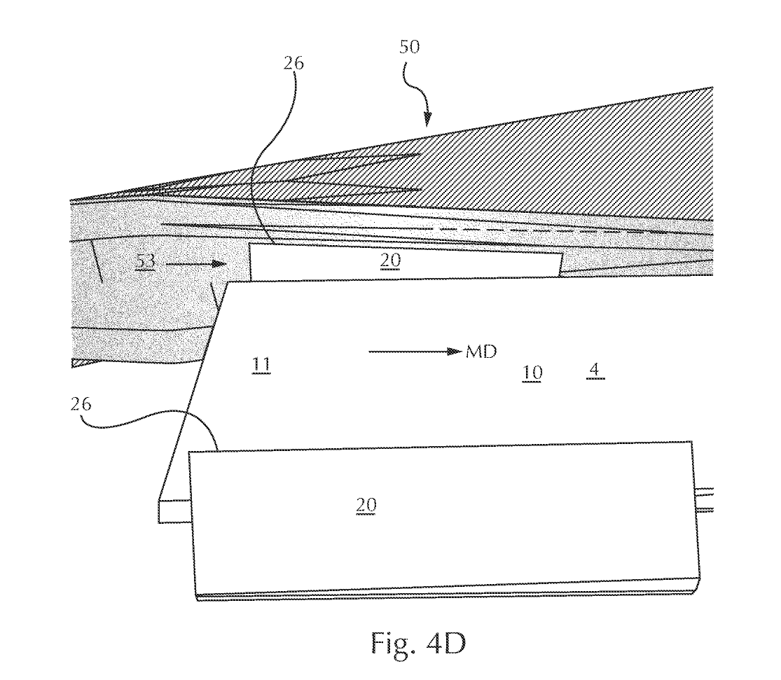

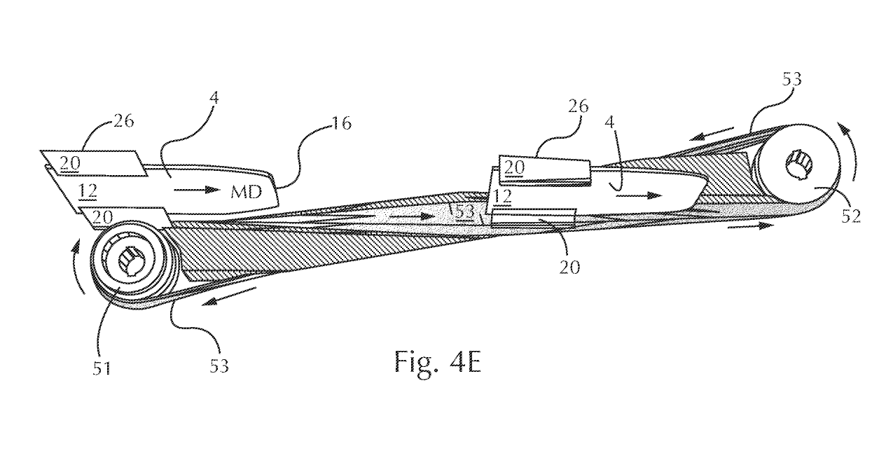

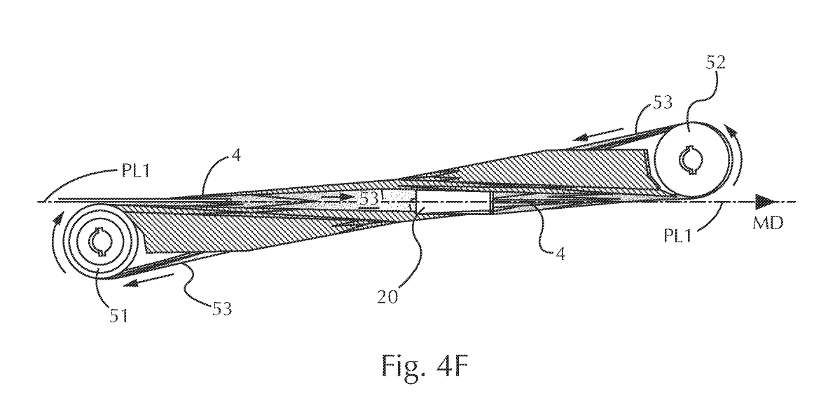

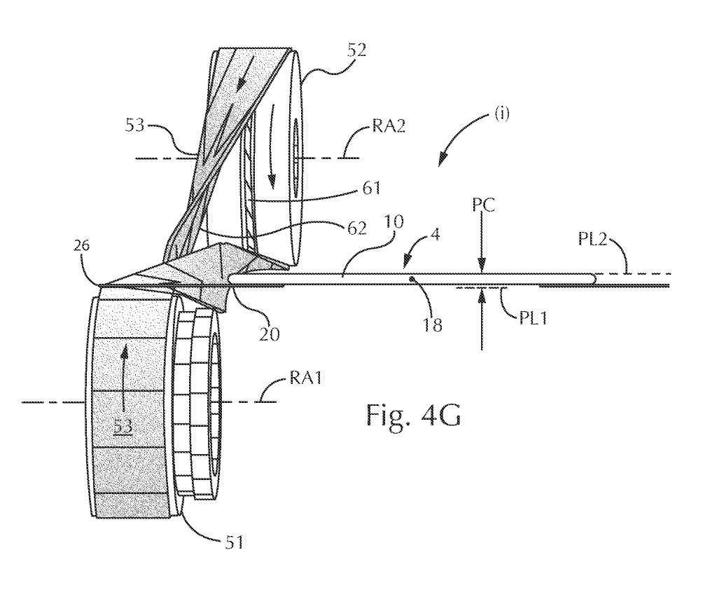

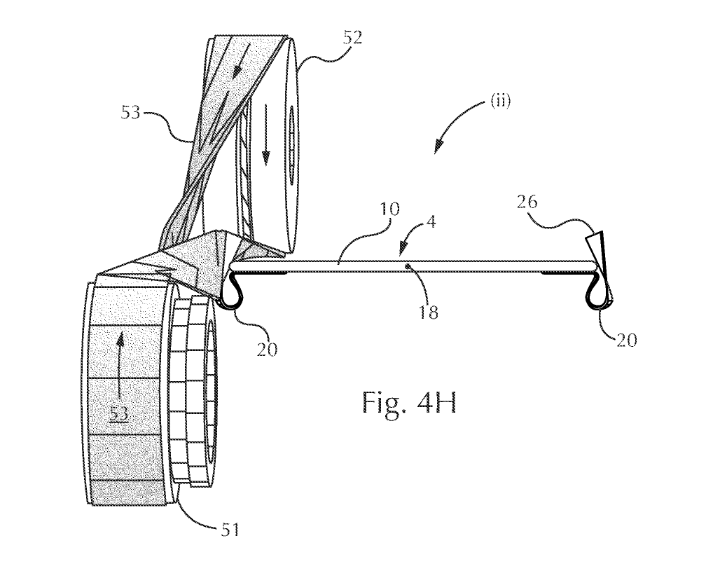

Belt 53 has inner (pulley-facing) and outer (outward-facing) surfaces, and may have a cross section having an aspect ratio of 2:1 (width:thickness) or more. To effect the change of side panel position reflected in the difference between FIGS. 2B and 2C, belt 53 may be twisted between 170 and 190 degrees, more preferably between 175 and 185 degrees, and even more preferably 180 degrees, as it rides between pulleys 51, 52, such that its outer surface twists or turns over by that amount as it leaves the first pulley, travels to and encounters the second pulley. It will be appreciated that the respective side edges 57, 58 of belt 53 have spiral paths between the pulleys having lengths that are greater than the path length of the longitudinal or middle axis of the belt, as a consequence of the twist. To accommodate the greater path lengths of edges 57, 58 while still enabling belt 53 to be in a taught condition about the pulleys at the longitudinal or middle axis, belt 53 may be formed of components including an elastomeric material. One suitable example may be a belt produced by Habasit AG, Reinach-Basel, Switzerland, having the designation FNB-8E-B[mm]-L[mm]-PVS-6. In order to help maintain belt/pulley alignment against lateral forces that may result from the twisted configuration and/or imperfections in the belt or pulley alignment, belt 53 may have one or more longitudinal ridges or grooves 62 on its inside surface; and one or both of pulleys 51, 52 may have one or more mating, circumferential ridges or “V”-shaped grooves 61. (See FIG. 4G). Alternatively, one or both of pulleys 51, 52 may have side walls or flanges (not shown) which laterally contain the belt and prevent lateral drift of the belt across the pulleys.

Referring again to FIG. 3, belt 53 may also have a pattern of vacuum holes or ports 59 therethrough, extending from the inner surface to the outer surface, so as to allow air to be drawn therethrough. In conjunction, twist belt mechanism 50 may also include a vacuum plenum 54, which may be disposed between pulleys 51, 52, and also between the lengths of belt 53 extending between the pulleys. Vacuum plenum 54 may have a shaped surface that matches and mates with the twisting path of inner surfaces of belt 53, and is in operable contact with those surfaces between the pulleys. The surface of vacuum plenum 54 in contact with belt 53 (as it travels from pulley 51 to pulley 52) may have openings or ports (not shown) by which fluid communication with vacuum ports 59, as they move thereover, is provided. Vacuum plenum 54 may be placed in fluid communication with a vacuum pump mechanism 56, which may be operated to draw a vacuum within vacuum plenum 54, and thereby draw air into and through vacuum ports 59 as belt 53 rides over the surface of vacuum plenum 54. Vacuum plenum 54 may also include, or be supported by, a shaped stationary guide structure 55, which supports and/or guides belt 53 as it travels from pulley 52 to pulley 51. The described vacuum system may be provided as a mechanism for capturing and retaining pliable members in contact with the twist belt as will be further described below. Where such a vacuum system is used, it may be desirable that twist belt 53 not have lateral grooves extending entirely across the inner surface, included for mating with teeth such as might be included on a driving pulley; such lateral grooves could be effective additional air channels, and compromise the effectiveness of the vacuum system.

In another example (not shown), as an alternative to a vacuum system for capturing and retaining pliable members, the outer surface of the twist belt may include a layer or pattern of hook components similar to hook-type components of hook-and-loop fastening systems (such as VELCRO hook-and-loop fastening systems). When the pliable members to be captured and retained included a layer of a fibrous woven, knitted or nonwoven material that will make operable contact with the twist belt, such hook components may be selected and included so as to engage the fibers of the material and capture the pliable members and retain them in contact with the twist belt during the turning/flipping operation.

In another alternative (not shown) to a vacuum system for capturing and retaining pliable members, a second twist belt and pulley system may be disposed in a facing relationship with operable portions of the first twist belt mechanism, such that the first and second twist belts are in facing relationship along operable lengths, and follow substantially mirror-image twisted paths along the operable lengths, and may thereby receive, grasp and carry the pliable members during the turning/flipping operation.

FIGS. 4A-4I are varying perspective views schematically depicting how twist belt mechanism 50 may be used to turn or flip side panels 20 laterally extending from precursor structures 4 as they are conveyed in a manufacturing line along a machine direction MD by a conveyor (not shown in FIGS. 4A-4I). As a precursor structure 4 is conveyed fold nose 16 first toward mechanism 50, a laterally extending side panel 20 comes into contact with the outer surface of belt 53 at first pulley 51 (see precursor structure 4 in position (i) with side panel 20 in foreground in FIG. 4A, and structure 4 with side panel 20 in FIG. 4G). As noted above, mechanism 50 may include a vacuum system, and belt 53 may have therethrough a pattern of vacuum ports (not shown in FIGS. 4A-4F) drawing air thereinto; as a side panel 20 rides onto the outer surface of belt 53, it is drawn onto and retained in relative fixed contact therewith by the vacuum, along the operable length of the belt outer surface. As the belt twists along its path from first pulley 51 to second pulley 52, side panel 20 is correspondingly turned over as shown, to a final position visible in FIG. 4A, with front end 26 of side panel 20 overlapping the longitudinal edge of chassis 10 by margin M (see precursor structures 4 in starting (i) intermediate (ii) and end (iii) positions in FIG. 4A, and precursor structures in starting (i), intermediate (ii) and end (iii) positions in FIGS. 4G-4I, respectively). It will be appreciated that precursor structures 4 may be conveyed so as to follow a machine direction MD lying along a plane PL1 (indicated by dashed line in FIG. 4F), and that first pulley 51 and second pulley 52 may have their axes parallel with but lying on either side of the plane PL1 so as to define a twist path for the belt appropriate to effect the desired placement of the side panel.

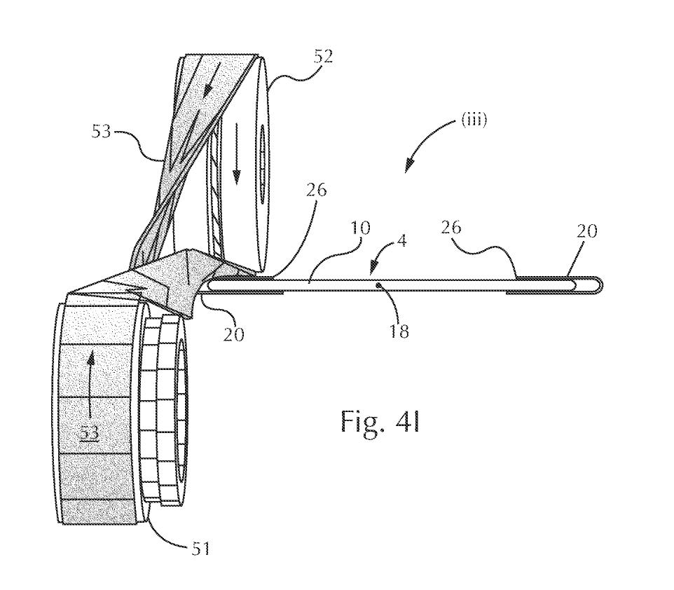

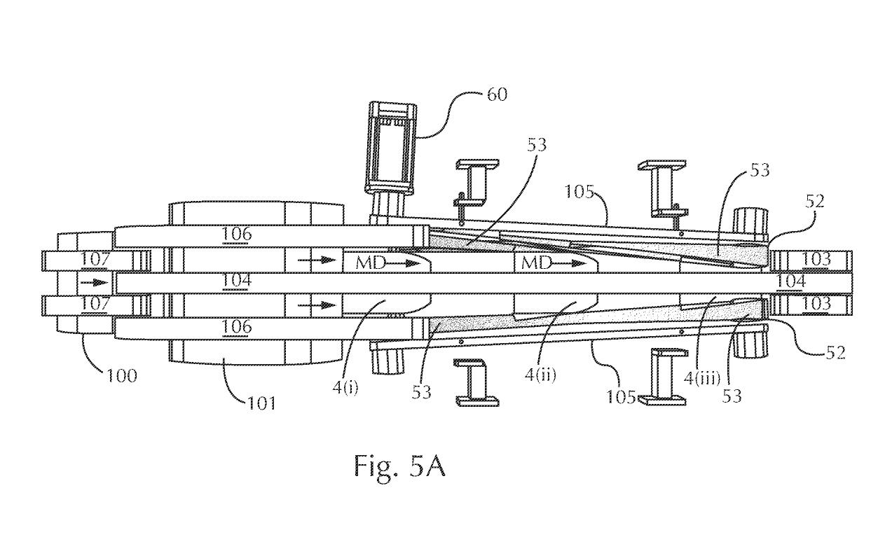

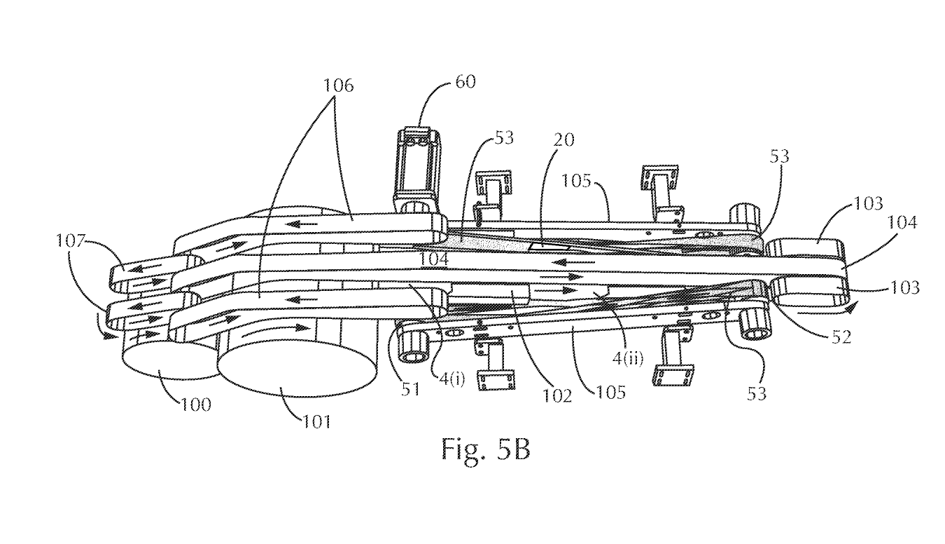

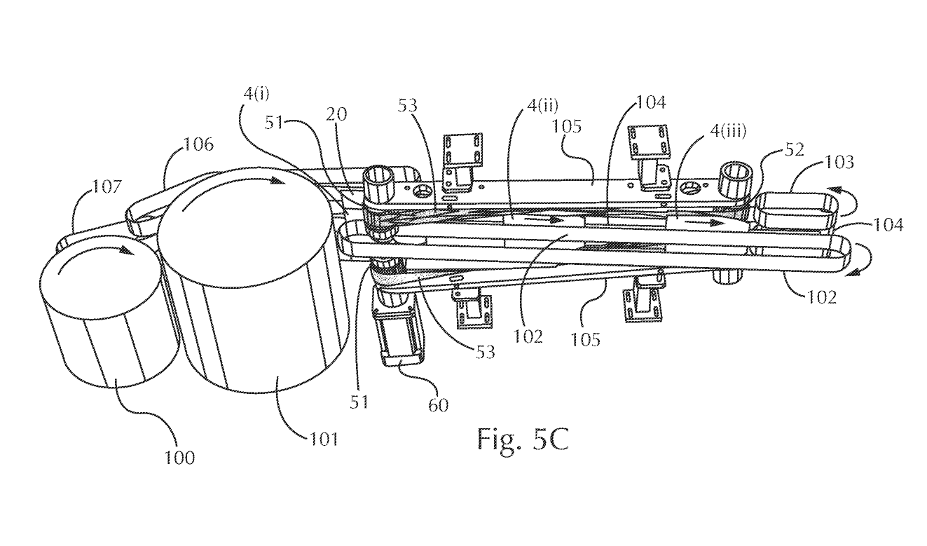

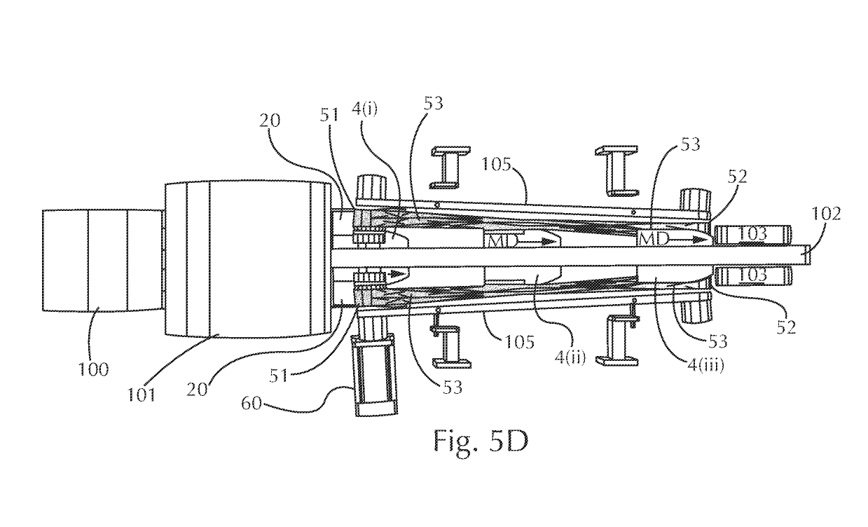

FIGS. 5A-5D illustrate how a cooperating pair of twist belt mechanisms may be incorporated into a member turning system, including a conveyor system. Precursor structures may be received at an infeed side including one or more roller drums 100, 101 and infeed belts 106, 107, which receive, grasp and convey the precursor structures and laterally-extending side panels thereof in the machine direction toward a conveyor. The conveyor may include facing conveyor belts 102, 104, which are driven about conveyor pulleys (not shown) such that their facing surfaces travel in a machine direction, at the same speed. Facing conveyor belts 102, 104 are disposed in suitably close facing relationship such that the folded precursor structures 4 are suitably securely grasped and conveyed therebetween in the machine direction. A pair of twist belt mechanisms as previously described, including first pulleys 51, second pulleys 52 and twist belts 53, may be disposed on either side of the machine direction pathway of the precursor structures. The pair of twist belt mechanisms may be positioned so as to simultaneously receive the pair of side panels 20 extending laterally from each precursor structure at the infeed location, and simultaneously effect the turning/flipping over of each of the side panel front ends 26 and positioning the same with the above-described margins M overlapping the front waist region. The twist belt mechanisms may be driven by one or more motors 60 connected to first pulleys 51. The one or more motors 60 may be servomotors which may be controlled to regulate speed and acceleration so as to appropriately regulate twist belt 53 speed relative the speeds of facing conveyor belts 102, 104. The twist belt mechanisms and conveyor system may be entirely or partially supported by frame 105.

Referring back to FIGS. 4G-4I, these figures illustrate three sequential positions a stretch panel 20 with its front waist edge will occupy relative the chassis 10 as it moves through the line in the machine direction. It can be seen that as the precursor structure 4 moves through the line, a portion of the laterally-extending side panel is retained on the belt and turned over, and also laterally shifted inwardly toward longitudinal axis 18; while the chassis 10 of precursor structure 4 remains in a laterally unchanged position.

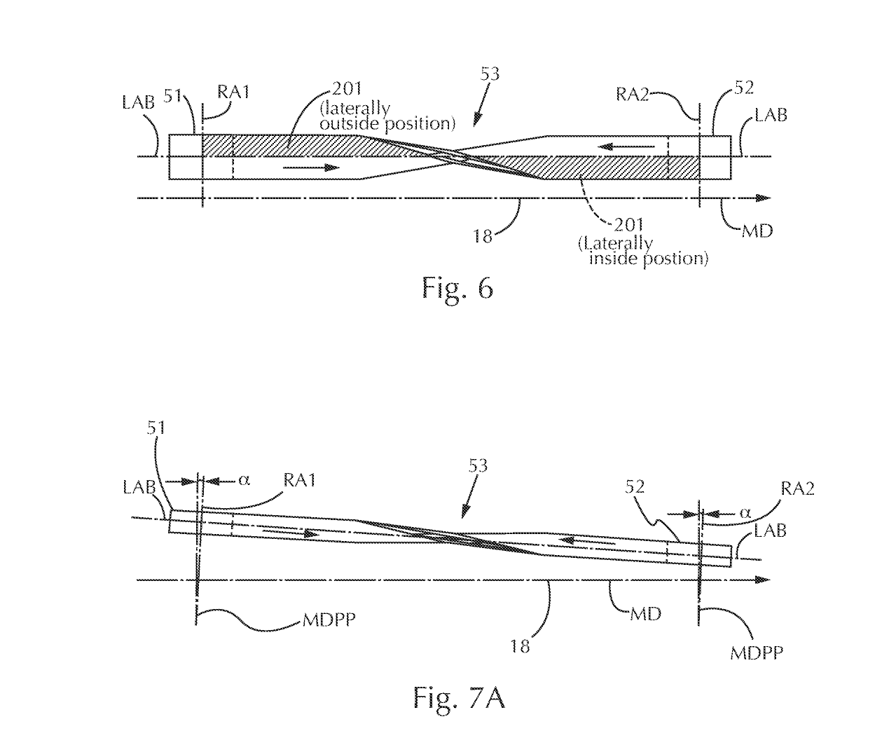

One way of accomplishing this turning and lateral shifting would be to use a twist belt at least as wide as the lateral width of the side panel to be grasped, with first and second pulleys 51, 52 arranged so that their rotational axes RA1, RA2 are substantially perpendicular to the machine direction; and further so that the longitudinal axis LAB of the belt 53 does not substantially converge toward or diverge away from the longitudinal axis 18 of the precursor structures as they travel in the machine direction MD, as the belt moves from first pulley 51 to second pulley 52. (See FIG. 6.) In this way, a laterally outboard portion of the side panel to be turned over may be retained by an operational portion 201 of the twist belt 53 occupying an laterally outside position (relative the longitudinal axes 18 of the moving precursor structures) at the receiving end, which will twist over to a laterally inside position at the exit end, thereby turning the grasped portion of the side panel over and also shifting it over laterally, as may be appreciated from FIG. 6. Thus, an arrangement such as or similar to that depicted in FIG. 6 requires a twist belt that is at least as wide as the width Ws (see FIG. 2B) of the portion of the side panel to be turned over.

With twist belts currently commercially available and having suitable long-wearing characteristics, it may be desirable that the distance between the rotational axes of the pulleys be at least 8, more preferably 9, and even more preferably 10 times the width of the belt to allow the belt to twist smoothly, with only insubstantial or no binding, kinking or creasing, as it travels between the pulleys. At the same time, it may be desirable to minimize the overall length and size of the twist belt mechanism in order to conserve valuable space within the manufacturing line. Thus, because the arrangement described in the preceding paragraph and depicted in FIG. 6 requires a twist belt 53 having a width at least as wide as the side panel to be grasped and turned over, it may require an undesirably long and/or large twist belt mechanism configuration.

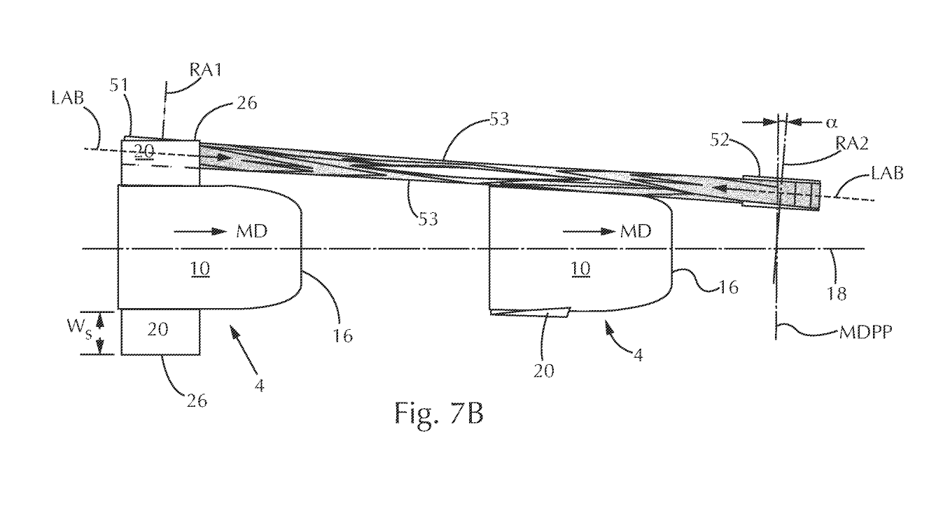

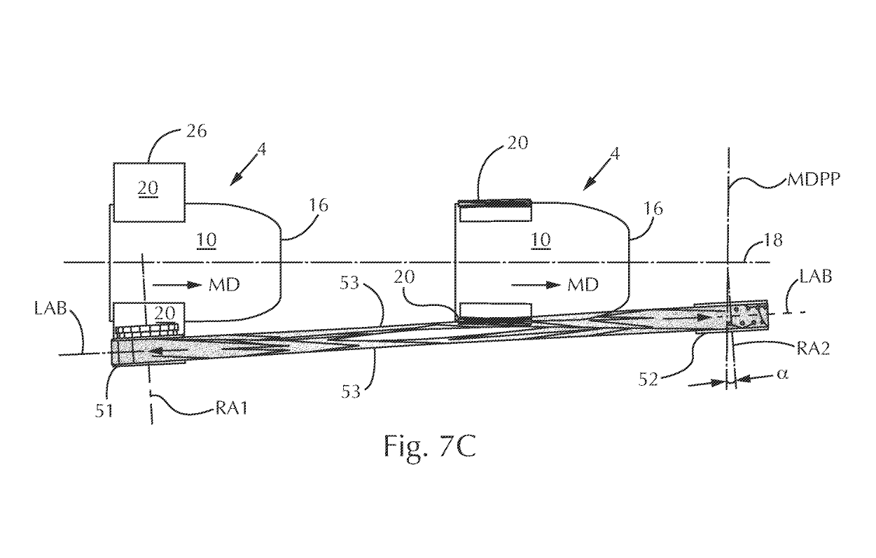

Accordingly, to reduce the space required for the twist belt mechanism, it may be desired that the belt 53 have a width less than the free side panel width Ws (see FIGS. 2B, 7B) of the side panels to be turned, prior to turning, as suggested in FIG. 7B.

A way to allow reduction of the width of the twist belt required to perform the desired operation (and thereby reduce the overall size of the twist belt mechanism required) can be appreciated from FIGS. 5A and 5D, and is more clearly illustrated in FIGS. 7A-7C. As suggested by these drawings, the rotational axes RA1, RA2 of first and second pulleys 51, 52 may be arranged such that they are not perpendicular with the machine direction MD. Rather, each of the pulleys 51, 52 may be oriented such that its rotational axis RA1, RA2 forms an angle α with a plane MDPP perpendicular to the machine direction MD, such that the longitudinal axis LAB of the belt 53 converges toward the longitudinal axis 18 of the precursor structures as they travel in the machine direction MD, as the belt moves from first pulley 51 to second pulley 52. In this configuration angle α will be greater than 0 degrees (a would be zero if the rotational axes RA1 and RA2 were perpendicular with the machine direction), and may be selected such that the amount of lateral shift of the belt desired is effected along the operational length of the belt. This lateral shift will correspond to the lateral position difference between the starting and finishing positions of the side panel edge 26, at the receiving and exit ends of the operational portion of the twist belt, respectively. Thus, angle α may be determinable via geometric or trigonometric calculation, using the desired distance of lateral shift of the front edge 26 of side panel 20 (from starting position to ending position) and the operable length and width of twist belt 53 available as determined by equipment design, specification and space constraints. When the rotational axes are arranged at an angle α as described, it may be desirable that the linear speed of the twist belt along its operative surface be greater than the conveyor speed, so that the machine direction velocity component of the twist belt speed matches the conveyor speed and there is not relative machine direction displacement between the operative surface of the twist belt and the conveyor. This will maintain consistent longitudinal positioning of the side panel relative the precursor structure as they move through the conveyor and twist belt mechanism. The motor and/or interconnecting, drive components driving the twist belt mechanism may be controlled to regulate the twist belt speed in coordination with the conveyor speed.

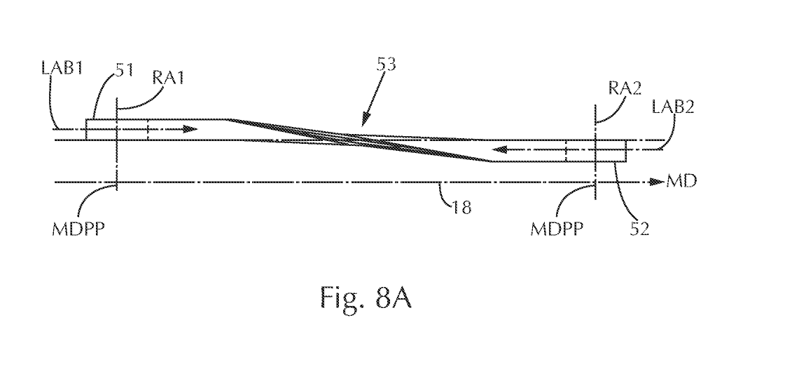

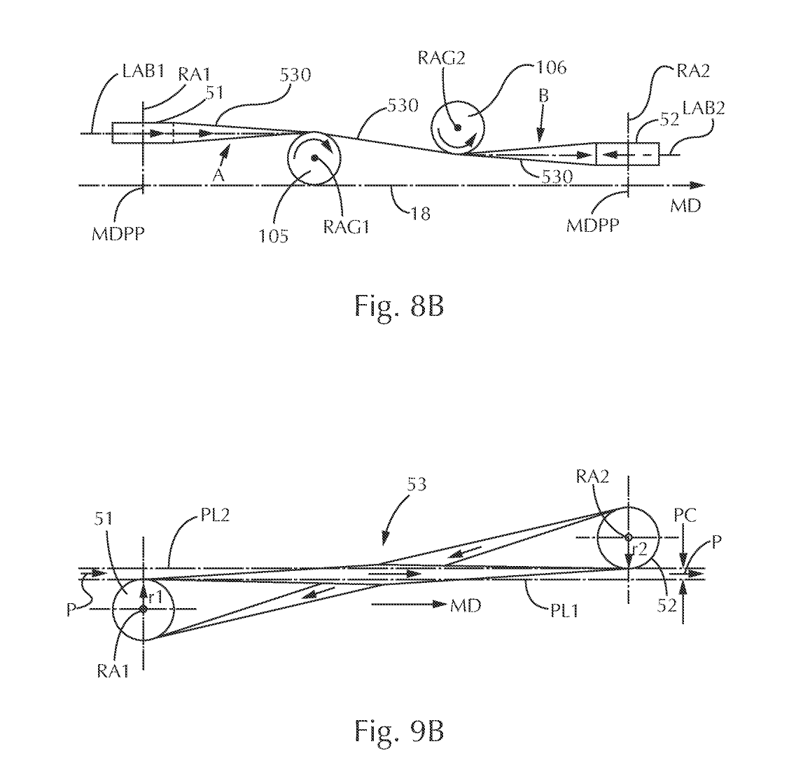

Another way to employ a twist belt of reduced width as described above, while still effecting the desired lateral shift of front ends 26 of side panels 20 may be appreciated from FIG. 8A. Pulleys 51 and 52 may be arranged such that each of their rotational axes RA1, RA2 is parallel with or lies within with a plane MDPP perpendicular to the machine direction MD (α is zero). However, to provide the required lateral shift without adding to belt width, respective pulleys 51, 52 may be laterally offset such that the longitudinal axis of the belt shifts laterally from position LAB1 to position LAB2, i.e., toward the longitudinal axis 18 of the precursor structures as they travel in the machine direction MD, as the belt moves from first pulley 51 to second pulley 52 as suggested in FIG. 8A. This arrangement may provide the advantage of receiving/retaining the side panels at the infeed side, and releasing/placing them at the exit side, along directions parallel with the machine direction and longitudinal axes of the precursor structures.

It may be appreciated from FIG. 8A that in such an arrangement, by itself, belt 53 when operated may tend to drift laterally out of its intended alignment about the pulleys and laterally offset belt axis positions LAB1, LAB2, and across the pulleys as the belt naturally seeks a straighter, shorter path. However, such movement may be prevented, and desired belt path/alignment maintained, through inclusion of appropriate additional shape features to the belt and/or pulleys, the vacuum plenum and/or stationary belt guide, or alternatively or in addition, appropriate guiding rollers located along the belt 53.

For example, as shown in FIG. 8B, pulleys 51 and 52 may be arranged such that each of their rotational axes RA1, RA2 is parallel or lies within with a plane MDPP perpendicular to the machine direction MD (α is zero). Respective pulleys 51, 52 may be laterally offset such that the longitudinal belt axis positions LAB1, LAB2 are laterally offset relative the longitudinal axes 18 of the precursor structures as they travel in the machine direction MD. To neutralize or counteract the forces in the twist belt that would tend to urge it to drift laterally, guiding rollers 105, 106, which may have substantially fixed axes RAG1, RAG2 relative pulleys 51, 52, may be included at least along the operative portion 530 of the twist belt. The rotational axes RAG1, RAG2 of guiding rollers 105, 106 may be parallel each other and form angles with respect to the rotational axes RA1, RA2 of pulleys 51, 52 (viewed along the machine direction), so as to each effect half of the total twist in the belt, respectively, at regions “A” and “B” (e.g., 90 degrees for each, if the total twist of the belt between pulleys 51, 52 is 180 degrees). The radii of guiding rollers 105, 106, and/or location of rotational axes RAG1, RAG2, may be selected and/or disposed such that the circumferential surfaces of the guiding rollers contacting the belt effect substantially all of the required lateral shift in the path of the belt, and enable the belt to approach and leave pulleys 51, 52 with reduced or no influence of forces that would urge the belt to drift laterally on the pulleys.

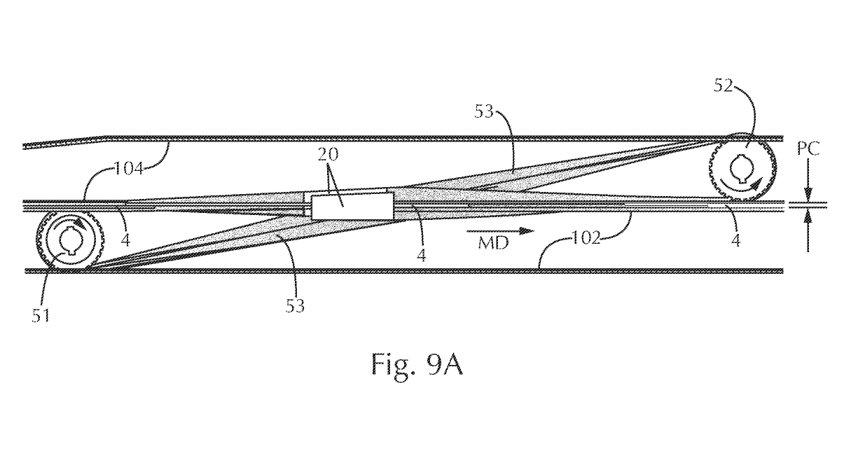

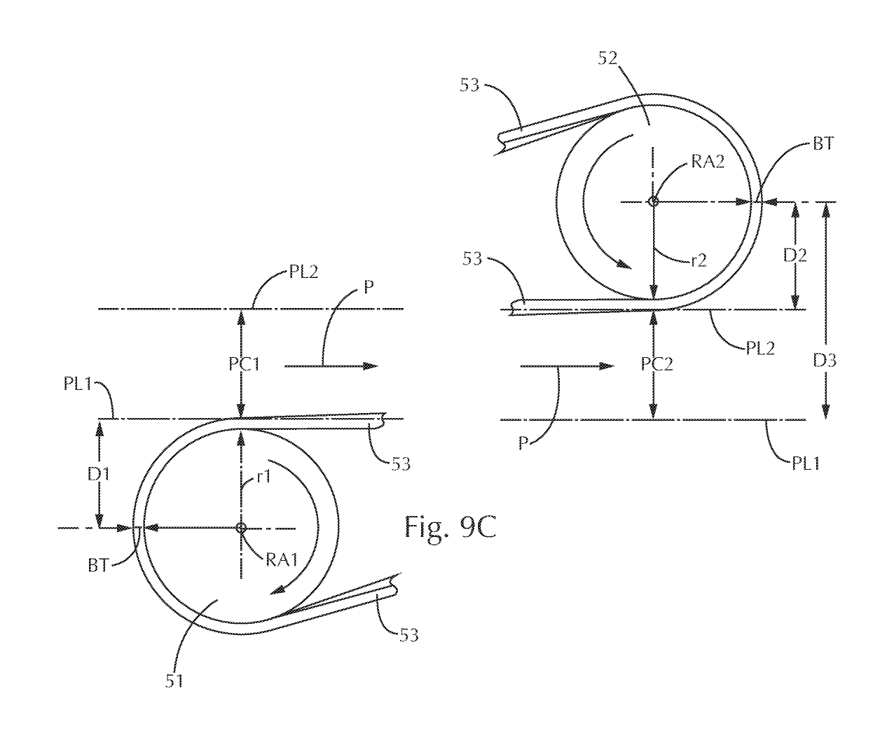

Referring to FIGS. 4G and 9A-C, it can be appreciated that the precursor structures 4 may be conveyed by the conveyor system and conveyor belts 102, 104 in the machine direction MD along a path P that defines planes PL1, PL2 along which the broadest surfaces of the chasses 10 of the precursor structures 4 move. Planes PL1, PL2 may be parallel. Planes PL1 and PL2 may also be defined by the facing surfaces of the respective conveyor belts 102, 104 as they grip the precursor structures, and are separated by a path thickness clearance PC. The path thickness clearance PC may be selected for the conveyor so as to accommodate the thickness of the folded precursor structures, which may be compressed to the extent desired to ensure secure grasping by the conveyor belts 102, 104 along the path. Thus, path thickness clearance PC will be greater than zero and less than or equal to the uncompressed thickness of the folded precursor structure.

Referring to FIGS. 9A and 9B, to ensure that the operative length of twist belt 53 follows a twist belt path that is appropriately arranged with respect to the path P of the precursor structures 4 between conveyor belts 102, 104 (shown in FIGS. 5A-5D and FIG. 9A), it may be desirable that at least one (both, if the twist is 180 degrees) of the rotational axes RA1, RA2 of pulleys 51, 52 is substantially parallel with at least one of planes PL1, PL2. Additionally, it can be appreciated from FIGS. 9B and 9C that rotational axis RA1 of pulley 51 may be located a first distance D1 from plane PL1, such that:

(r1+BT)≧D1≧r1,

where (r1+BT) is the total of the radius of pulley 51 beneath the belt, and thickness BT of the belt, i.e., the total distance from the rotational axis RA1 to the outer surface of the belt at a location where the belt is fully engaged about the pulley. The location of PL1 is determined when a folded chassis 10 of a precursor structure 4 is present between the conveyor belts in the area adjacent rotational axis RA1 as in operation. The positional relationship described above enables the twist belt to receive a side panel 20 in approximately or exactly the same plane as plane PL1, which may help to minimize alignment problems in some circumstances.

It can also be appreciated from FIGS. 9B and 9C that rotational axis RA2 of pulley 52 may be located a second distance D2 from plane PL2, such that:

(r2+BT)≧D2≧r2,

where (r2+BT) is the total of the radius of pulley 52 beneath the belt, and thickness BT of the belt, i.e., the total distance from the rotational axis RA2 to the outer surface of the belt at a location where the belt is fully engaged about the pulley. The location of PL2 is determined when a folded chassis 10 of a precursor structure 4 is present between the conveyor belts in the area adjacent rotational axis RA2 as in operation. The positional relationship described above enables the twist belt to discharge a side panel 20 in approximately or exactly the same plane as plane PL2, which may help to minimize alignment problems in some circumstances.

However, in some circumstances it may be desirable that the twist belt 53 compress the side panel onto the chassis 10 to some extent, such as, for example, when an adhesive is disposed on the side panel and/or the chassis so as to effect adherence therebetween, and wherein the pressure would help distribute adhesive between the respective surfaces and promote adhesive bonding. In these circumstances, rotational axis RA2 of pulley 52 may be located a second distance D2 from plane PL2, or a third distance D3 from plane PL1, such that:

D2<(r2+BT), or even

D2<r2; or alternatively,

(PC2+r2+BT)>D3>(r2+BT),

where PC2 is the clearance between the faces of conveyor belts 102, 104 adjacent rotational axis RA2 of pulley 52, with a chassis 10 grasped therebetween as in operation.

It will be appreciated that, to complete the article structure illustrated in FIG. 1, it is necessary to affix the side panels 20 along front ends 26 to the front waist region 11. One method of performing this step may include applying an adhesive material or a cohesive material to either or both of the outer side of front waist region 11, and the inner side of side panels 20 along front ends 26, prior to turning of side panels 20 by the twist belt system. This step may be employed to tack down and hold the side panels in the desired position for a later bonding step, or alternatively, such adhesive/cohesive bonding may be the only bonding used to affix the side panels to the front waist region. Following the cohesive/adhesive applying step, the precursor structure may be conveyed past the twist belt mechanism which turns over and places the side panel at the desired location on the front waist region. The configuration described immediately above, which may be selected to compress the side panels against the front waist region, may be utilized to create a more secure adhesive bond. In addition or in another alternative, the precursor structure may be passed through another pair of facing conveyor belts or facing rollers (not shown), downstream of the twist belt system and configured to receive the structure and compress the side panels against the front waist region, and thereby help distribute adhesive between the respective facing surfaces of the front waist region and side panels and promote a more secure adhesive bond therebetween.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for turning a pliable web member extending laterally from a precursor structure, having longitudinal axis, as the precursor structure is conveyed along a machine direction at a conveyance speed, comprising the steps of:
conveying the precursor structure along a machine direction on a conveyor, the machine direction following a substantially straight line along the conveyor;
receiving at least a portion of the pliable web member onto an operative twisting moving surface defined by a twisted moving belt situated alongside the conveyor;
wherein the pliable web member has a free width, and the twisted moving belt has a belt width, and the belt width is less than the free width;
retaining the portion of the pliable web member in contact with the operative twisting moving surface;
driving the twisted moving belt at a speed coordinated with the conveyance speed such that the operative twisting moving surface moves generally along the machine direction, thereby conveying the retained portion of the pliable web member alongside the moving precursor structure and turning the portion of the pliable web member over by movement of the operative twisting moving surface; and
releasing the portion of the pliable web member from the belt.

2. The method of claim 1 further comprising the step of applying a vacuum to the twisting moving belt to effect said retaining step.

3. The method of claim 1 wherein the precursor structure has an outer surface and the pliable web member has an inner surface, the method further comprising the step of applying an adhesive or cohesive material to said outer surface and/or said inner surface prior to the receiving step.

4. The method of claim 3 further comprising the step of compressing a portion of the pliable web member onto the outer surface.

5. The method of claim 5 wherein the belt rides on first and second pulleys rotating about respective first and second rotational axes.

6. The method of claim 5 wherein the first and second rotational axes arc perpendicular to the machine direction; the precursor structure moves along an axis of travel parallel with the machine direction, and the twisted moving belt has a first longitudinal axis position on a first pulley and a second longitudinal axis position on a second pulley, wherein the second longitudinal axis position is nearer the axis of travel than the first longitudinal axis position, and whereby the twisted moving belt shifts laterally as it moves from the first pulley to the second pulley.

7. The method of claim 5 wherein each of the first and second rotational axes forms an angle that is greater than 0 degrees, with a plane perpendicular to the machine direction.
